(19) United States
(12) Patent Application Publication
(10) Pub. No.: US 2002/0089996 A1
(43) Pub. Date: Jul. 11, 2002

(54) Communication node and communication unit

(76) Inventors: Chiyoko Komatsu, Kawasaki (JP); Yoshinobu Takagi, Kawasaki (JP); Hirotaka Morita, Kawasaki (JP)

Correspondence Address: ROSENMAN & COLIN LLP, 575 MADISON AVENUE, NEW YORK, NY, 10022-2585, US

(21) Appl. No.: 09/819,397

(22) Filed: Mar. 28, 2001

(30) Foreign Application Priority Data
Nov. 13, 2000 (JP) 2000-345669

(51) Int. Cl. H04B 7/212

(52) U.S. Cl. 370/442; 370/351

(57) ABSTRACT

A communication node comprises a backplane transmission circuit capable of accomplishing transmission of a signal between communication units installed in a plurality of slots and a signal waveform control unit for controlling a waveform of the signal in accordance with a transmission distance of the signal between the communication units in the backplane transmission circuit. This arrangement achieves stable fast backplane transmission of a main signal without increasing the degree of parallelism for the main signal, thus realizing a high-extensibility small-sized communication node capable of dealing with as a very-high large-capacity bit rate as 40 Gbps, 160 Gbps or a bit rate exceeding these values.

### BACKGROUND OF THE INVENTION

(1) Field of the Invention

The present invention relates to a communication node and a communication unit, and more particularly to a communication node and a communication unit, suitable for use as transmission equipment according to a transmission mode in a new synchronous network such as SONET (Synchronous Optical Network) or SDH (Synchronous Digital Hierarchy).

(2) Description of Related Art

FIG. 14 is a front view illustratively showing an appearance of a transmission apparatus (communication node) applicable to the existing SONET/SDH transmission system. In FIG. 14, a node, designated generally at numeral 100, is an apparatus (which will be referred to hereinafter to a “10 G node”) designed to handle 10 Gbps [SONET OC (Optical Carrier)—192/SDH STM (Synchronous Transfer Module)—64], and is made up of a shelf (sub-rack) 110 serving as an apparatus housing and various types of units designed according to function as listed below, with each of these units being fixedly installed in a predetermined slot of the shelf 110.

| Receive Units (RC) | 111A, 111B |
|---|---|
| Demultiplexing Units (DM) | 112A, 112B |
| Four Sets of Work (Operating)/Protection | 113W/P to 116W/P |
| (Standby) Branch/Insertion Units (MM) | |
| Multiplexing Units (MX) | 117A, 117B |
| Transmission Units (TC) | 118A, 118B |
| Synchronization Units (SC) | 121A, 121B |
| Alarm Orderwire Unit (AWU) | 131 |
| Transport Complex Interface (HED) Units | 132A, 132B |
| Craft Interface Unit (CRF) | 133 |
| DCC (Data Communication Channel) Terminating | 134A, 134B |
| Units | |
| Memory Unit | 135 |
| CPU (Central Processing Unit) Cards | 136A, 136B |
| Power-Supply Unit (PW) | 137 |

Each of the foregoing receive units 111A and 111B functions as a high-order group interface for receiving an optical signal (OC-192) with a capacity of 10 Gbps, and for achieving their main functions, is equipped with a preamplifier, an optical-electrical (photoelectric) converter (O/E) and other devices. For “1+1 configuration”, one of these receive units 111A and 111B is used as an operating unit, while the other as a standby unit. On the other hand, for application in a ring network or the like, both (one is for EAST direction, and the other for WEST direction) are used as an operating unit.

Each of the aforesaid demultiplexing units 112A and 112B is for demultiplexing a main signal from the corresponding receive unit 111A or 111B into low-order group channel signals (equivalent to OC-48), while the branch/insertion units 113W/P to 116W/P are equipped with interfaces for the low-order group channel signals from the demultiplexing units 112A and 112B.

For the application of this 10 G node 100 to a ring network, however, the operating branch/insertion units 113W to 116W are used as interface (IF) units for the EAST direction, while the standby branch/insertion units 113P to 116P are used as interface (IF) units for WEST direction.

The multiplexing units 117A and 117B are for concentrating and multiplexing the low-order group channels signals from the branch/insertion units 113W/P to 116W/P in units of capacity of 10 Gbps.

Each of the transmission units 118A and 118B is for converting a multiplexed signal from the corresponding multiplexing unit 117A or 117B into an optical signal (OC-192) to output it to a high-order group interface (optical line), and for this feature, it is equipped with an electrical-optical converter (E/O), a post-amplifier and other devices.

Accordingly, a block (communication unit group) comprising the receive units 111A, 111B, the demultiplexing units 112A, 112B, the branch/insertion units 113W/P to 116W/P, the multiplexing units 117A, 117B and transmission units 118A, 118B constitutes a transport complex section (main signal block) 101 as illustratively shown in FIG. 15.

Moreover, the foregoing synchronization units 121A and 121B constitute a synchronization complex section (synchronization block) 102 (see FIG. 16) for offering a timing synchronization function of this 10 G node 100, and exhibit, say, a reference clock collecting function, a timing distributing function, a synchronization message processing function, or the like. Incidentally, this synchronization block 102 is frequently treated as a portion of the main signal block 101. In addition, an HUB unit 122 is for providing an interface between a management complex section 103 (see FIG. 17), which will be mentioned later, and the aforesaid transport complex section 101.

Still moreover, the alarm orderwire unit 131 is for offering an alarm orderwire function, and each of the HED units 132A and 132B is for exhibiting a polling control function or an overhead interface (overhead termination/replacement, or the like), and further the craft interface unit 133 is for providing a craft interface, a DCC (Data Communication Channel) terminating function, or the like, and even the DCC terminating units 134A and 134B is for displaying a DCC terminating function.

Furthermore, the CPU (Central Processing Unit) cards 136A and 136B are for entirely controlling the aforesaid main signal block 101 and the aforesaid units 131, 132A, 132B, 133, 134A and 134B to provide a supervision (monitor) control function for this 10 G node 100. In this case, these two CPU cards 136A and 136B take care of load distributed processing Still furthermore, the memory unit 135 is for storing software or data needed for when the CPU cards 136A and 136B operate, and further for offering a working memory area needed for when the supervision (monitor) and control function operates, while the power-supply unit 137 is for supplying power to the management complex section 103.

That is, a block comprising the alarm orderwire unit 131, the HED units 132A, 132B, the craft interface unit 133, the DCC terminating units 134A, 134B, the memory unit 135 and the CPU cards 136A, 136B constitutes the management complex section (supervision and control block) 103 for offering the supervision control function of this shelf 100, as illustratively shown in FIG. 17.

In addition, a main signal inputted to the 10 G node with the above-mentioned configuration transfers through paths, shown in FIG. 18, in the main signal block 101. Accordingly, in this 10 G node 100, as illustratively shown in FIG. 20, connectors 201 each for each slot to which connected is each of the units organizing the main signal block 101 and a printed circuit board (PCB) on which formed are signal wiring for unit-to-unit communications (signal transmission), and others are placed on the rear surface of the shelf 110. The printed circuit board 200 is called a back wired board (BWB) or backplane interface (backplane transmission circuit).

In addition, for example, when each unit is pressed into the interior of the shelf 110 along guides (rails) 140 installed on upper and lower inner wall surfaces of the shelf 110 according to slot, a connector 150 set on the back surface of each unit is engaged with the connector 201 for each slot located on the backplane interface (which hereinafter be referred to simply as a “backplane”) 200, thereby setting up the unit-to-unit communication enabling condition.

At this time, the concrete connections among the units 111A, 111B, 112A, 112B, 113W/P to 116W/P, 117A, 117B, 118A and 118B constituting the foregoing main signal block 101 are as shown in FIG. 19.

That is, when the bit rate of a receive signal assumes 10 Gbps, the connections between the receive unit 111A (111B) and the demultiplexing unit 112A (112B) and between the multiplexing unit 117A (117B) and the transmission unit 118A (118B) are made through 622 Mbps×16 parallel signal lines placed on the back wired board 200, while the connections between the demultiplexing unit 112A (112B) and the branch/insertion units 113W to 116W (113P to 116P) and between the branch/insertion units 113W to 116W (113P to 116P) and the multiplexing unit 117A (117B) are made through 311 Mbps×32 parallel signal lines placed on the back wired board 200.

In this way, the existing 10 G node 100 has employed, as an interface between the units to be connected through the back wired board 200, a mode in which 10 G-capacity data (main signal) are transmitted as 311 Mbps×32 or 622 Mbps×16 parallel data.

In FIG. 19, signal paths (wiring) denoted by broken lines are not put to use for when this node 100 is for use in a ring network [the aforesaid work/protection is used as EAST/WEST (that is, the protection is also used as the operating system)].

Furthermore, the wiring for the units constituting the supervision and control block 103 is not located on the back wired board 200, and for example, the interchange of information (supervision, control, overhead, and others) between the supervision and control block 103 and the main signal block 101 is conducted through the HED units 132A, 132B and the HUB unit 122 using a 155.52-Mbps optical fiber (optical link) installed on the front surface of the shelf 110, as shown in FIG. 17.

Meanwhile, in the latest several years, the bit rate of an optical line in a SONET/SDH transmission system has been speeded up from the conventional 2.5 Gbps (giga bit per second) to 10 Gbps as mentioned above, and the super speed-up to 40 Gbps and to 160 Gbps may be realizable in the feature. For this reason, also for nodes organizing a SONET/SDH transmission system, a very-fast and large-capacity apparatus is expected which can handle a bit rate above 40 Gbps.

The main current bit rate to be handled in the nodes of the SONET/SDH transmission system is 10 Gbps (OC-192/STM-64) as stated above, and the next apparatus requires promoted development of a node capable of handling a very-high bit rate of 40 Gbps (OC-768/STM-256), more preferably 160 Gbps (OC-3072/STM-1024).

Therefore, for example, in the above-mentioned arrangement (interface) of the existing 10-Gbps handling backplane 200, although there may be a simple method of realizing a 40-Gbps handling node by increasing the amount of signal wiring (degree of parallelism), this requires transmission of a huge amount of parallel signal on the backplane 200, such as 128 parallels for 311 Mbps and 64 parallels for 622 Mbps, and for this reason, extreme difficulty is experienced in realizing it at the same size as that of the 10 G node 100 or smaller apparatus scales. It goes without saying that it would be impossible to realize a higher (for example, 160 Gbps) and large-capacity node with size reduction.

However, the next-generation very-fast and large-capacity node, such as 40 Gbps or 160 Gbps, is required to have not only a high performance but also an apparatus scale of the same or smaller size as compared with that of the conventional 10 G node, thus requiring, in addition to the size reduction of the respective units to be installed therein, the speed-up and high-density integration of the backplane 200.

That is, it is necessary to increase the bit rate of each signal line without changing the amount of signal wiring (degree of parallelism) on the backplane 200, whereas the existing backplane 200 and the existing devices/materials are limited to the aforesaid bit rate such as 311 Mbps or 622 Mbps from the viewpoint of stable transmission of main signals. If the main signals are transmitted at a higher bit rate on the backplane 200, the main signal waveform deforms largely even in a relatively short distance between slots of the backplane 200 due to the loss characteristics of the signal lines; in consequence, difficulty is encountered in putting them into practical use.

Moreover, the signaling rate (capacity) on the backplane is an important factor for determining a transmission capacity of a system and, in its turn, an application menu of the system, and for this reason, not until the realization of a high bit rate handling backplane, it becomes possible to cope with the extension of the system.

### SUMMARY OF THE INVENTION

Accordingly, the prevent invention has been developed in consideration of the above-mentioned problems, and it is therefore an object of the invention to provide a small-sized and largely-extensible communication node capable of stably accomplishing main signal transmission on a backplane at a high rate without increasing the degree of main signal parallelism, thus coping with very-high and large-capacity bit rate transmission of 40 Gbps/160 Gbps or more.

For this purpose, in accordance with the present invention, there is provided a communication node comprising a backplane transmission circuit for accomplishing transmission of a signal between communication units installed in a plurality of slots, and a signal waveform control unit for controlling a waveform of the signal on the basis of position information on the communication unit installing slots in the backplane transmission circuit.

The communication node thus arranged according to the invention controls the waveform of a signal to be transmitted on a backplane transmission circuit (which will hereinafter be referred to simply as a “backplane”) on the basis of position information on a communication unit installing slot, thereby reforming (compensating for) the deterioration of a signal waveform according to the positional relationship (that is, transmission distance) between slots which appears remarkably as a signal transmission rate increases. This realizes stable signal transmission at all times while maintaining the signal quality needed for the signal transmission between the communication units.

Thus, it is possible to achieve a stable high-speed transmission of a signal between the communication units without increasing the degree of parallelism of a signal to be transferred on the backplane, which can provide a small-sized communication node with a very-high rate and a large capacity.

In this case, it is also appropriate that the foregoing signal waveform control unit includes a installing slot position information collecting section for collecting the communication unit installing slot position information and a waveform correction information generating section for generating waveform correction information corresponding to the signal transmission distance on the basis of the installing slot position information collected in the installing slot position information collecting section so that the waveform control is implemented on the basis of the waveform correction information generated in the waveform correction information generating section.

With this arrangement, the installing slot position information are collected automatically at the installing of the communication units, the start-up of the apparatus, or the like to obtain a signal transmission distance between the slots so that the generation of the waveform correction information corresponding to the obtained transmission distance takes place and contributes to the waveform control according to the signal transmission distance, which can eliminate the need for the manual setting of waveform correction information for the waveform control.

Accordingly, considerable simplification of the setting work for the waveform control becomes possible and the setting error or the like is avoidable.

In a case in which a transmission circuit with a transmission signal amplitude control function is provided in the signal transmission side communication unit and the signal waveform control unit is designed to implement the waveform control by controlling an amplitude control value in the transmission circuit, the signal waveform control according to transmission distance is realizable by the amplitude control on the signal transmission side.

Furthermore, when a reception circuit with a receive signal amplitude control function is provided in the signal receive side communication unit and the signal waveform control unit is designed to implement the waveform control by controlling an amplitude control value in the reception circuit, the signal waveform control according to transmission distance is realizable by the amplitude control on the signal receive side. As a matter of course, a combination of the amplitude control on the transmission side and the amplitude control on the receive side is also possible.

In either case, the waveform control is certainly executable according to the signal transmission distance.

Still furthermore, it is also appropriate that the signal waveform control unit is provided in both the signal transmission side communication unit and signal receive side communication unit so that the signal waveform control units make communication with each other to determine an amplitude control value of the signal for accomplishing the waveform control. This can realize the waveform control without placing the signal waveform control unit independently of the communication units. Accordingly, this contributes greatly to the reduction of the apparatus scale of the communication node.

In addition, it is also appropriate that each of the communication units is equipped with an error correcting circuit for correcting an error of the signal. This allows the signal error to be correctable with the error correcting circuit at the time of fast signal transmission where signal errors tend to occur even from slight disturbance such as variation of apparatus environment.

In this case, it is also possible that the error correcting circuit in the signal transmission side communication unit is made to add error correction information for error correction to the signal and the error correcting circuit in the communication unit on the signal receive side is made to perform the error correction on the basis of the error correction information added to the signal. This can provide error correction with high accuracy through the enhancement of the signal rate, and the effect is certain signal error correction on the basis of the error correction information.

Accordingly, further speed-up (capacity development) of the signal transmission on the backplane becomes feasible in a state of being maintained in stability.

Moreover, it is also appropriate that the backplane is equipped with an extension connection section used for additionally installing the communication unit for the slot and an extension signal wiring section for establishing communication between the communication unit additionally installed and connected to the extension connection section and the other existing communication unit. Thus, it is possible to increase the signal transmission capacity of the backplane for achieving the above-mentioned stable fast signal transmission without enlarging the apparatus scale.

Accordingly, this can flexibly deal with the speed-up and capacity development of the transmission system in the future, and can significantly reduce new apparatus development cost.

Furthermore, in accordance with the present invention, there is provided a communication unit comprising a transmission circuit for transmitting a signal to a communication unit installed in another slot of a backplane and a transmission side waveform control circuit for controlling a waveform of the signal transmitted from the transmission circuit on the basis of installing slot position information on the communication unit installed in the another slot.

In the communication unit thus arranged according to the invention, the waveform of a signal to be transmitted to the backplane is controllable according to the positional relationship (that is, transmission distance) with respect to the slot accommodating another communication unit forming the other communication party. This can reform (compensate for) the signal waveform deterioration corresponding to the transmission distance which appears remarkably as a signal transmission rate increases, thus realizing stable signal transmission at all times while maintaining the signal quality needed for the signal transmission between the communication units.

In addition, in accordance with the present invention, there is provided a communication unit comprising a reception circuit for receiving a signal from a communication unit installed in another slot of a backplane and a receive side waveform control circuit for controlling a waveform of the signal received in the reception circuit on the basis of installing slot position information on the communication unit installed in the another slot.

In the communication unit thus arranged according to the invention, the waveform of a signal received from the backplane is controllable according to the positional relationship (that is, transmission distance) with respect to the slot accommodating another communication unit forming the other communication party. This also can reform (compensate for) the signal waveform deterioration corresponding to the transmission distance which appears remarkably as a signal transmission rate increases, thus realizing stable signal transmission at all times while maintaining the signal quality needed for the signal transmission between the communication units.

### BRIEF DESCRIPTION OF THE DRAWINGS

FIG. 1 is a perspective view illustratively showing a SONET/SDH node according to an embodiment of the present invention;

FIG. 2 is a block diagram showing principally a configuration of essential parts of an interface unit, a multiplexing unit (multiplexing unit, transmission unit) and a control unit in the node of FIG. 1;

FIG. 3A is an illustration useful for explaining a “pre-emphasis” method according to this embodiment of the invention;

FIG. 3B is an illustration useful for explaining an “edge emphasis” method according to this embodiment;

FIG. 4 is a block diagram showing an example of configuration of the control unit shown in FIG. 2;

FIGS. 5A and 5B are illustrations of examples of management tables for emphasis and attenuation (attenuator) control according to this embodiment;

FIG. 6 is an illustration useful for explaining an operation (emphasis attenuation control) of the node shown in FIG. 1;

FIG. 7 is a flow chart useful for explaining the operation (emphasis attenuation control) of the node shown in FIG. 1;

FIG. 8 is a block diagram useful for explaining a modification of an optimum adjustment method for an emphasis (attenuation) control value in this embodiment;

FIG. 9 is a front view illustratively showing principally a slot layout of the node shown in FIG.

FIG. 10 is a block diagram useful for explaining an example of wiring (for installing of four pairs of 40-Gbps handling optical sending units and optical receiving units) on a backplane interface shown in FIGS. 1 and 2;

FIG. 11 is a front view illustratively showing principally a slot layout of the node shown in FIG. 1;

FIG. 12 is a block diagram useful for explaining wiring used on the backplane interface shown in FIGS. 1 and 2 in the case of installing of two pairs of 40-Gbps handling optical sending units and optical receiving units and one pair of 80-Gbps handling WDM optical sending unit and optical receiving unit;

FIG. 13 is a block diagram showing an example of a network realized through the use of a node with the used wiring shown in FIG. 12;

FIG. 14 is a front view illustratively showing an appearance of a transmission apparatus (communication node) applicable to the existing SONET/SDH transmission system;

FIG. 15 is a perspective view illustratively showing principally a configuration of a transport complex section in the transmission apparatus shown in FIG. 14;

FIG. 16 is a perspective view illustratively showing principally a configuration of a synchronization complex section in the transmission apparatus shown in FIG. 14;

FIG. 17 is a perspective view illustratively showing principally a configuration of a management complex section in the transmission apparatus shown in FIG. 14;

FIG. 18 is an illustrative perspective view useful for explaining a transmission path for a main signal in the transport complex section shown in FIG. 15;

FIG. 19 is a block diagram useful for explaining the connection relationship between units constituting the transport complex section shown in FIGS. 15 and 18; and

FIG. 20 is an illustrative perspective view useful for explaining a method of installing units in a shelf of the transmission apparatus shown in FIG. 14.

### DESCRIPTION OF THE PREFERRED EMBODIMENTS

An embodiment of the present invention will be described hereinbelow with reference to the drawings.

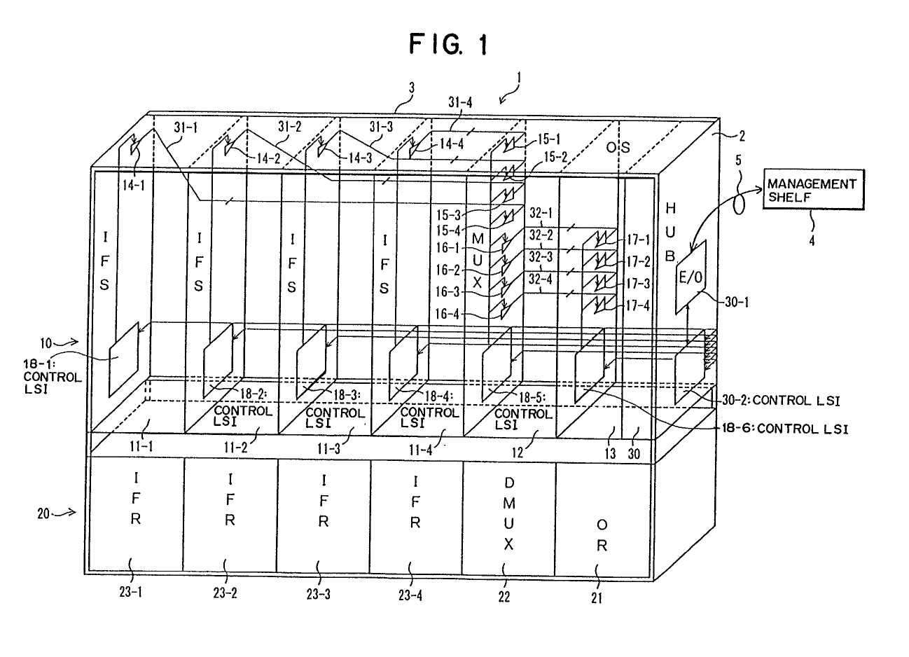

FIG. 1 is a perspective view illustratively showing a SONET/SDH node according to an embodiment of the present invention. A SONET/SDH 1 (which will hereinafter be referred to simply as a “node 1”) is shown in FIG. 1 as also comprising a shelf (rack) 2 forming an apparatus housing and a plurality of units designed according to function as listed below, with each of these units being inserted into a predetermined slot of the shelf 2 as with the conventional node so that signal connection is set up through a backplane interface 3 (which will hereinafter be referred to simply as a “backplane 3”) placed on the back surface of the shelf 2.

| Interface Units for Sending (IFS) 11-1 to | |
|---|---|
| 11-4 | |
| Multiplexing Unit (MUX) | 12 |
| Optical Sending Unit (OS) | 13 |
| Optical Receiving Unit (OR) | 21 |
| Demultiplexing Unit (DMUX) | 22 |
| Interface Units for Receiving (IFR) 23-1 | |
| to 23-4 | |
| HUB Unit | 30 |

In FIG. 1, on the upper section of the shelf 2, the connection relationship between the respective units 11-1 to 11-4, 12, 13, 30 and the backplane 3 is shown with a perspective image. In addition, in FIG. 1, although principally shown are configurations (slots) for the operating (EAST side) IFS 11-i (i=1 to 4), the multiplexing unit 12 and the optical sending unit 13 (an optical receiving unit 21, a demultiplexing unit 22 and IFR 23-i), in fact, as with the above-described 10 G node 100, standby (WEST side) units (slots) are provided in connection therewith, with signal wiring for connection similar to that in the operating system being installed on the backplane 3 in a state paired with the signal wiring in the operating system.

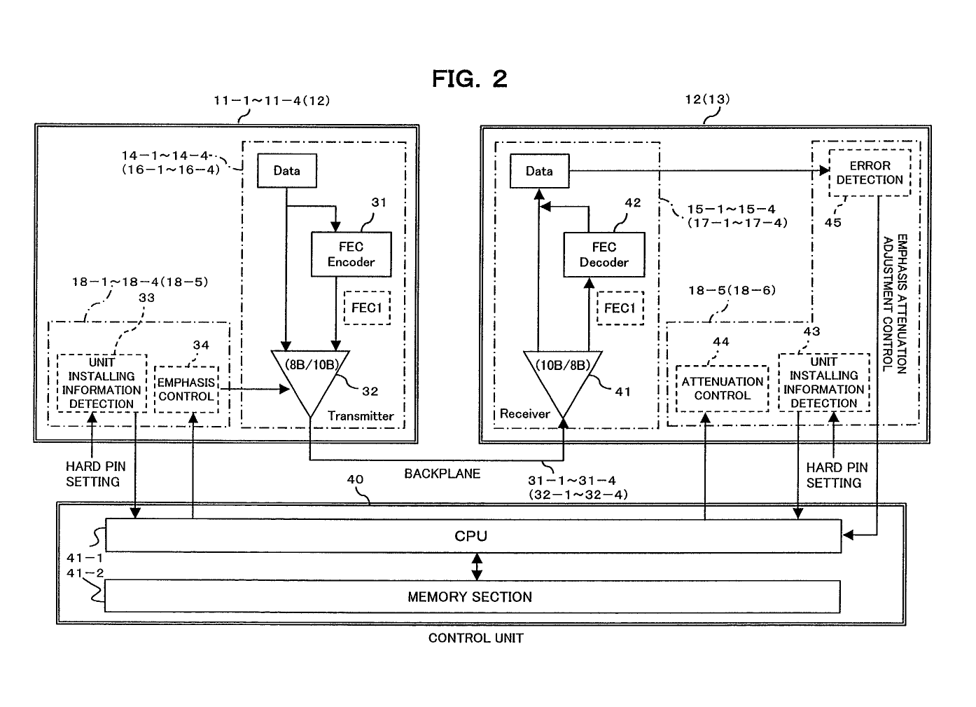

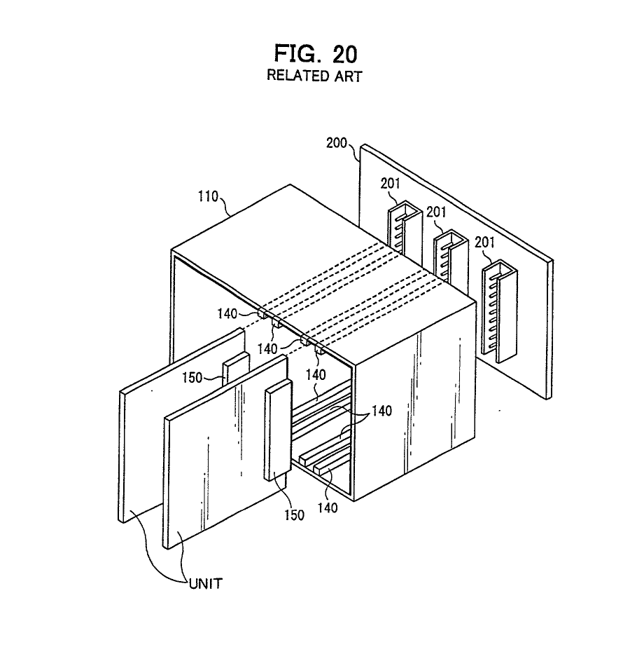

Moreover, a method of installing the foregoing units 11-i, 12, 13, 21, 22, 23-i and 30 in the shelf 2 is similar to the method described above with reference to FIG. 20. Still moreover, in FIG. 1, reference numeral 4 designates a management shelf (equivalent to the aforesaid supervision and control block 103) connected through an optical link (optical fiber) 5 to the HUB unit 30, with a control unit 41 (see FIG. 2) for signal waveform control in backplane transmission, which will be mentioned later, being installed in the management shelf 4.

A description will be given hereinbelow of the basic functions of the units 11-i, 12, 13, 21, 22 and 23-i.

First, in the upper section of the shelf 2, each of the interface units for sending (IFS) 11-i converts a main signal (low-order group channel signal; for example, a signal corresponding to 10 Gbps capacity when this node is of a type handling 40 Gbps, and a signal corresponding to 20 Gbps capacity for 80 Gbps) from a low-order group interface (optical line) into an electric signal to send it from a transmission circuit 14-i to the multiplexing unit 12 through a signal line (main signal line) 31-i placed on the backplane 3.

The multiplexing unit 12 is for receiving, through the use of the corresponding reception circuits 15-i, main signals transmitted from the transmission circuits 14-i of the interface units (IFS) 11-i through the signal lines 31-i on the backplane 3 to multiplex them, and further for sending the multiplexed signals from the corresponding transmitting circuits 16-i through the signal lines (main signal lines) 32-i on the backplane 3 to the optical sending unit 13.

The optical sending unit 13 receives, through the use of the corresponding reception circuits 17-i, the main signals (multiplexed signals) transmitted from the transmitting circuits 16-i of the multiplexing unit 12 through the signal lines 32-i on the backplane 3 to convert the respective received signals into optical signals, and further for sending them to a high-order group interface (optical line).

That is, the IFS 11-i are equivalent to a transmission side communication unit to the multiplexing unit 12, and the multiplexing unit 12 is equivalent to the receive side communication unit to the IFS 11-i and further equivalent to the transmission side communication unit to the optical sending unit 13, and further, the optical sending unit 13 is equivalent to the receive side communication unit to the multiplexing unit 12.

As FIG. 1 shows, control LSI circuits (Large Scale Integrated circuits) 18-1 to 18-6 are additionally provided in the aforesaid units 11-i, 12 and 13, respectively. The transmission circuits 14-i of the corresponding units 11-i, 12 and 13, or the reception circuits 15-i and 17-i, are controlled by the LSI circuits 18-1 to 18-6, as will be described later, so that the waveforms of the main signals transmitted on the backplane 3 are controlled according to their transmission distances (the lengths of signal lines 31-i and 32-i).

On the other hand, in the lower section of the shelf 2, the optical receiving unit 21 converts an optical signal (multiplexed signal) from the aforesaid high-order group interface into an electric signal to send it, as a main signal, through the backplane 3 to the demultiplexing unit 22, and the demultiplexing unit 22 demultiplexes the main signal handed over from the optical receiving unit 21 into low-order group channel signals to distribute them through the backplane 3 to the corresponding interface units for receiving (IFR) 23-i, with each of the interface units 23-i converting the main signal from the demultiplexing unit 22 into an optical signal to send it to the low-order group interface (optical line).

That is, in the node shown in FIG. 1, the IFS 11-1 to 11-4, the multiplexing unit 12, the optical sending unit 13, the optical receiving unit 21, the demultiplexing unit 22 and the IFR 23-1 to 23-4 organize a main signal block to offer a main signal transmission function. Of these units, a block comprising the optical sending unit 13, the multiplexing unit 12 and the IFS 11-1 to 11-4, installed in the upper section of the shelf 2, exhibit a main signal transmission function (transmission block 10), while a block comprising the optical receiving unit 21, the demultiplexing unit 22 and the IFR 23-1 to 23-4, installed in the lower section of the shelf 2 display the main signal receive function (receive block 20).

Incidentally, although not shown, as in the case of the configuration of the transmission block 10, transmitters and receivers are installed in the units 21, 22 and 23-i constituting the receive block 20 installed in the lower section of the shelf 2, with these transmitters and receivers being connected through signal lines on the backplane 3 in a one-to-one basis. In addition, an LSI circuit is also provided in each unit so that the signal waveform control is implemented according to transmission distance of a main signal to be transmitted on the backplane 3, as will be described later, as in the case of the transmission block 10 side.

Furthermore, the HUB unit 30 is for presenting a signal concentration/distribution function between the transmission block 10 and the receive block 20, and further for realizing transmission/reception of supervision and control information with respect to the management shelf 4 through the optical link 5. Noting the connection with the transmission block 10, the electrical-optical converter (E/O) 30-1 and an LSI circuit 30-2 lie therein as shown in FIG. 1.

Thus, in the HUB unit 30, the supervision information obtained in the LSI circuits 18-j (j=1 to 6) installed in the units 11-i, 12 and 13 are sent through the backplane 3 to be collected in the LSI circuit 30-2 and then fed through the optical link 5 to the management shelf 4, while the control information from the management shelf 4 is transferred properly through the LSI circuit 30-2 to the LSI circuit 18-j installed in the units 11-i, 12 and 13.

In this embodiment, for the enhancement of the basic bit rate, the main signal transmission (which will be referred to hereinafter as “backplane transmission”) on the backplane 3 employs a 2.5 (to 5.0) Gbps×16 parallel data transmission mode instead of the conventional 311 Mbps×32 parallel or 622 Mbps×16 parallel data transmission mode.

However, when the bit rate in the backplane transmission reaches a high bit rate on the order of Gbps, the transmission loss stemming from the loss characteristics of the signal lines 31-i and 32-i increases to promote the deterioration of the main signal data waveforms. What's more, this waveform deterioration varies with the main signal data transmission distance (signal wiring distance; distance between slots) on the backplane 3.

In addition, an error tends to occur in the main signal data due to slight variation of apparatus environment [temperature, power-supply voltage, electromagnetic compatibility (EMC)], disturbance, difference in circuit element characteristic, or the like. The EMC signifies a general term of the electromagnetic interference (EMI) delivered from the apparatus and the electromagnetic susceptibility of the apparatus.

For this reason, in this embodiment, an error correction code is added to main signal data of 2.5 (to 5.0) Gbps to produce main signal data of 2.7 (to 5.4) Gbps with a error correction code, and through continuous code limitation, averaging of mark rates, parity error detection or the like, a code conversion based on 8B/10B conversion is made in order to reduce the main signal data inter-code interference so that the main signal data of 2.5 (to 5.0) Gbps ultimately reaches 3.375 (to 6.75) Gbps before transmitted, and even the wavelength correction of the main signal data is perform individually between each pair of slots.

Incidentally, it is also acceptable that the aforesaid error correction code is inserted into undefined data (undefined data of the overhead, or the like) of the main signal data so as not to increase the signaling rate. However, since the limitation imposed on error correction code length (or size) to be added is relaxed more when an error correction code is added to the exterior of main signal data to increase the signaling rate as mentioned above than when inserted in this way, higher-accuracy error correction code addition becomes possible.

The above-mentioned arrangement enables normal and stable very-fast backplane transmission at a basic bit rate on the order of Gbps, such as 2.5 (to 5.0) Gbps, without increasing the degree of parallelism (number of signal lines) for the main signal on the backplane 3. Thus, with an equivalent or smaller apparatus scale as compared with the conventional 10 G node 100, it is possible to realize the node 1 capable of handling 40 Gbps (in the case of the basic bit rate of the backplane transmission being set at 2.5 Gbps) to 80 Gbps (in the case of being set at 5.0 Gbps).

Accordingly, in this embodiment, the main function of the IFS 11-i, the multiplexing unit 12 (multiplexing unit 12, optical sending unit 13) and the control unit 40 are as shown in FIG. 2.

That is, in the IFS 11-i (multiplexing unit 12), for example, an FEC encoder 31 and a transmitter 32 are provided as the foregoing transmission circuit 14-i (16-i) while a unit installing information detecting section 33 and an emphasis control section 34 are provided as the LSI circuit 18-i (18-5). In the multiplexing unit 12 (optical sending unit 13), a receiver 41 and an FEC decoder 42 are placed as the aforesaid reception circuit 15-i (17-i) while a unit installing information detecting section 43, an attenuation (or attenuator) control section 44 and an error detecting section 45 are placed as the LSI circuit 18-5 (18-6).

In addition, at least a CPU 41-1 and a memory section 41-2 are installed as, for example, a CPU firmware in the control unit 40.

The FEC encoder 31 of the transmission circuit 14-i (16-i) and the FEC decoder 42 of the reception circuit 15-i (17-i) function as an error correction circuit based on FEC (Forward Error Correction), and for example, the FEC encoder 31 generates the aforesaid error correction code (for example, Reed-Solomon code or the like; error correction information) which in turn, is added to the main signal data by the transmitter 32, while the FEC decoder 42 decodes the error correction code added to the received main signal data to perform the main signal data error correction through the use of the decoded code, thus compensating for errors developed in the main signal data originating from the variation of the apparatus environment (temperature or power-supply voltage, EMC), disturbance, difference in circuit element characteristic, or the like.

Furthermore, the transmitter 32 of the transmission circuit 14-i (16-i) is for outputting main signal data [2.7 (to 5.4) Gbps] with the aforesaid error correction code through a predetermined port to the signal line 31-i (32-i) on the backplane 3. At this time, as stated above, the bit rate of the main signal data is increased from 2.7 (to 5.4) Gbps to 3.375 (to 6.75) Gbps by means of the 8B/10B conversion. For this reason, this transmitter 32 includes an output buffer or the like (not shown).

Meanwhile, the receiver 41 of the reception circuit 15-i (17-i) is for receiving the main signal data with the error correction code from the aforesaid transmission circuit 14-i (16-i), received through the signal line 31-i (32-i) on the backplane 3 and the predetermined port from. At this time, contrary to the aforesaid transmitter 32, the bit rate [3.375 (to 6.75) Gbps] of the received main signal data is reverse-converted into 2.7 (to 5.4) Gbps by means of the 10B/8B conversion. For this reason, this receiver 41 also includes an output buffer or the like (not shown) as well as the transmitter 32.

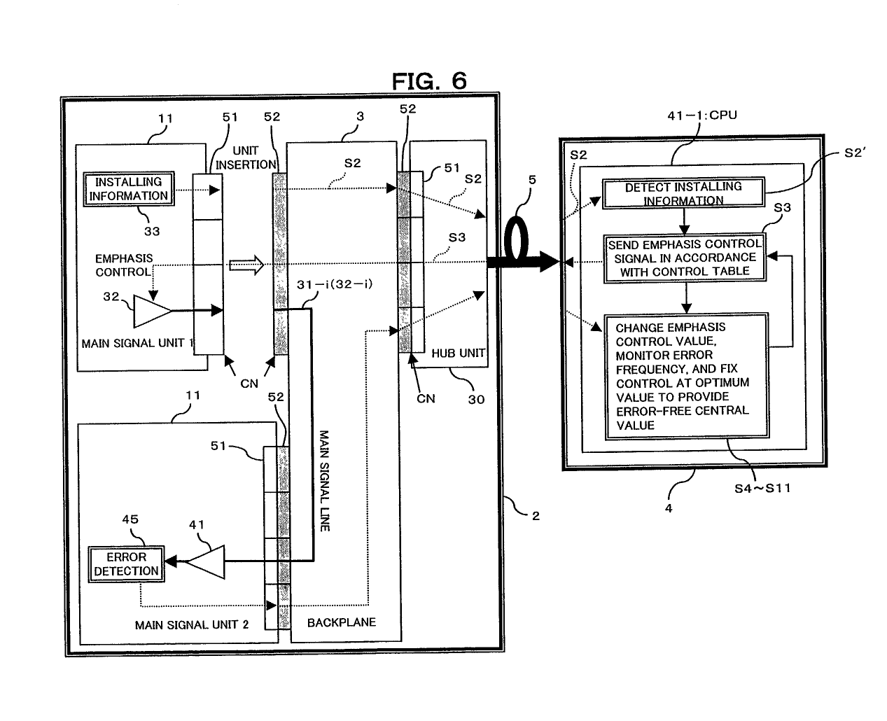

Furthermore, each of the aforesaid unit installing information detecting sections 33 and 43 is for detecting whether or not the aforesaid unit 11-i, 12 or 13 is installed in the backplane 3 (concretely, whether or not connectors 51 and 52 are connected to each other as illustratively shown in FIG. 6), thereby detecting unit installing information (slot address data; installing slot position information) representative of the slot the unit 11-i, 12 or 13 is installed in.

Concretely, the aforesaid “slot address data” is obtainable as bit array data different according to slot in a manner that, for example, when the “open-state” of a connecting pin of the connector 52 on the backplane 3 side is represented by a bit “1” while the “ground-state” thereof is represented by a bit “0”, the open/ground array (called a “hard pin setting”) is changed as being different according to slot. The detected slot address data is communicated through the optical link 5 to the CPU 41-1 of the control unit 40.

The emphasis control section (transmission side waveform control circuit) 34 is for implementing waveform control according to the main signal data transmission distance on the backplane 3 by controlling (emphasis control) the output signal waveform (amplitude) of the transmitter 32 of the transmission circuit 14-i (16-i), with, for example, the “pre-emphasis” method or “edge emphasis” method being employable as a control method therefor.

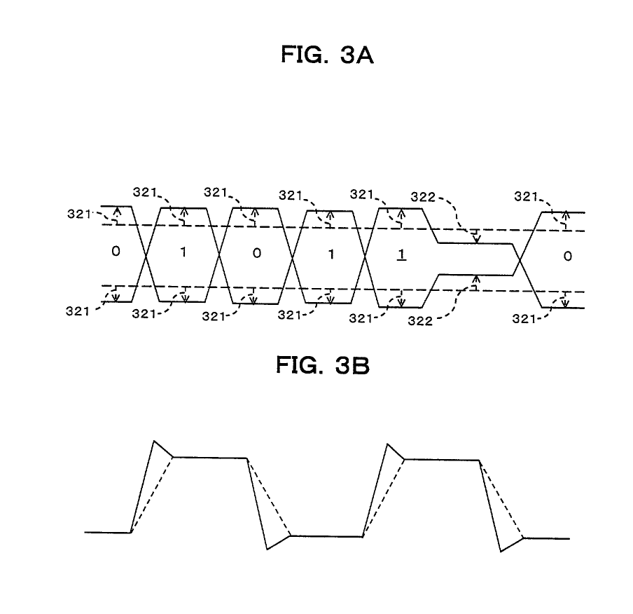

Concretely, according to the former “pre-emphasis” method, for example as illustratively shown in FIG. 3A, the output of the transmitter 32 is amplitude-emphasized (see arrows 321 indicated by broken lines) in discontinuous code portions while the amplitude thereof is attenuated (see arrows 322 indicated by broken lines) on second and subsequent bits in continuous code portions (11 . . . , 00 . . . , and others), thereby reforming the deterioration of an eye pattern opening portion of data (which will be referred to hereinafter as a “data eye”) stemming from continuous code interference. In addition, since there is no need to output a signal amplitude-emphasized at all times in the continuous code portions, the transmitter 32 can reduce its power consumption.

This “pre-emphasis” control is realizable by detecting the continuous code at the output stage of the transmitter 32 to control the output buffer. In this connection, the reverse signal control on the receive side is called “equalization” control.

On the other hand, according to the latter “edge emphasis” method, the reforming of the waveform deterioration (rounding) is made in a manner that, for example, a high-speed type is employed as the output buffer of the transmitter 32 only for edge portions of a signal waveform to sharpen the leading and trailing edges of that waveform as shown illustratively in FIG. 3B.

However, in this embodiment, the foregoing backplane transmission includes clock-less data transmission, but is designed to employ a method of regenerating clocks from the main signal data; therefore, the employment of the former “pre-emphasis” method is effective from the viewpoint of securing the data eye.

Accordingly, the transmission circuit 14-i (16-i) acts as a transmission circuit with a transmission signal amplitude control function provided in the main signal data transmission side unit 11-i (12) and serves as a reception circuit with a receive signal amplitude control function provided in the main signal data receive side unit 12 (13), thus controlling the amplitude control value in these circuits in accordance with a control signal from the control unit 40 to execute the waveform control according to the main signal data transmission distance on the backplane 3.

Furthermore, in the receive side LSI circuit 18-5 (18-6), the attenuation control section (receive side waveform control section) 44 controls the input waveform of the main signal data received in the receiver 41 through the backplane 3 [signal line 31-i (32-i)], in accordance with a control signal from the CPU 41-1 of the control circuit 40, thereby implementing the waveform control according to the main signal data transmission distance on the backplane 3. For example, this function is realizable by adjusting the degree of attenuation in a variable attenuator (not shown) provided at an input portion of the receiver 41.

The error detecting section 45 uses the aforesaid error correction code to detect an error of the main signal data received in the receiver 41, with the detection result being communicated (feedbacked) to the CPU 41-1 of the control unit 40.

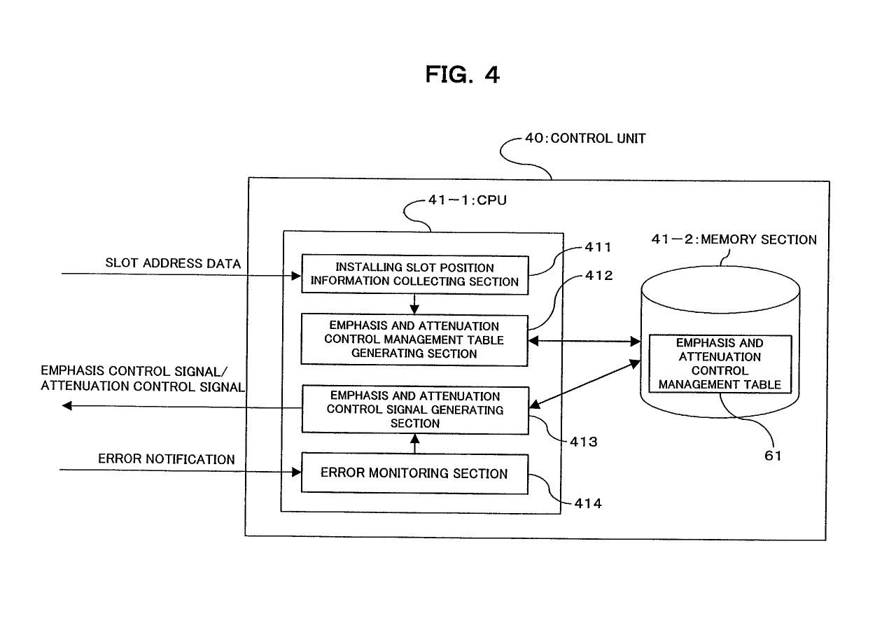

In addition, in the control unit 40, the CPU (signal waveform control unit) 41-1 takes care of the waveform correction control according to the main signal data transmission distance at the aforesaid backplane transmission. Noting the function of the essential part thereof, for example, as shown in FIG. 4, it is made up of a installing slot position information detecting section 411, an emphasis and attenuation control management table generating section 412, an emphasis and attenuation control signal generating section 413 and an error monitoring section 414.

The installing slot position information detecting (collecting) section 411 is for detecting (collecting) the aforesaid slot address data detected and communicated by the unit installing information detecting sections 33 and 43 at the start-up (power-on) of the apparatus or unit installing, and the emphasis and attenuation control management table generating section (waveform correction information generating section) 412 is for generating a management table (waveform correction information) for the emphasis control and the attenuation control on the basis of the slot address data collected in the installing slot position information collecting section 411.

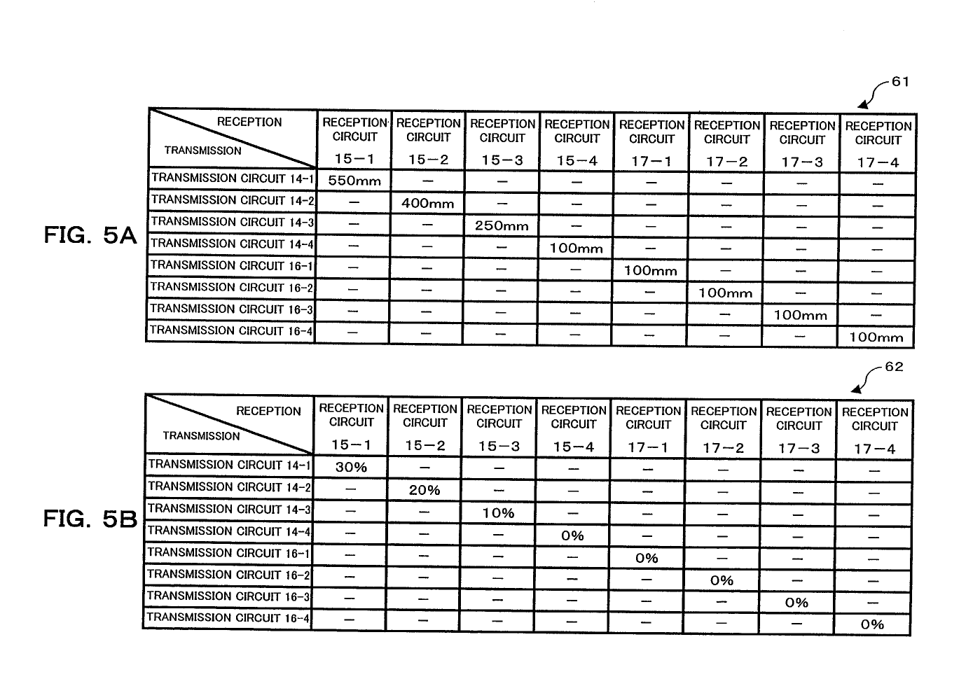

Concretely, this emphasis and attenuation control management table generating section 412 (sometimes, which will hereinafter be referred to simply as a “management table generating section 412”) confirms which slot and ports are chosen for signal-connection, on the basis of the collected slot address data, and encodes the inter-port distances (transmission distances) according to transmission/reception, thereby generating a management table 61 shown in FIG. 5A. On the basis of this management table 61, for example, with reference (0%) being made to a transmission distance of 100 mm (millimeter), an optimum amplitude control value (emphasis quantity for a transmission distance longer than the reference, and attenuation quantity for a shorter transmission distance; for example, approximately 10 to 30%) according to transmission distance is encoded to generate an emphasis and attenuation control management table 62 shown in FIG. 5B.

For example, the management tables 61 and 62 are stored in the memory section 41-2. However, there is no need for both the management tables 61 and 62 to be always preserved in the memory section 41-2, and it is also acceptable if the emphasis and attenuation control management table 62 is finally put in the memory section 41-2.

In addition, this memory section 41-2 retains the port connection relation (correspondence of port position information) on each slot as table format data, and on the basis of this data, the management table generating section 412 recognizes which slot and ports are chosen for signal-connection as mentioned above. That is, the CPU 41-1 is made to previously recognize the slot and its ports to be used for the signal-connection.

The aforesaid emphasis and attenuation control signal generating section 413 sees the emphasis and attenuation control management table 62 generated in the management table generating section 412 as stated above to generate an emphasis control signal/attenuation control signal for the emphasis control section 34 for the transmitter 32 or the attenuation control section 44 for the receiver 41, or for both, stated above with reference to FIG. 2. The generated control signal is fed through the optical link 5 to the LSI circuit 30-2 of the HUB unit 30, and then forwarded from the LSI circuit 30-2 to the corresponding LSI circuit 18-1 to 18-6.

In this connection, it is appropriate to implement both the emphasis control and attenuation control, or to perform any one of the emphasis control for the transmitter 32 of the transmission circuit 14-i (16-i) in the main signal transmission side unit 11-i (12) and the attenuation control for the receiver 41 of the reception circuit 15-i (17-i) in the main signal receive side unit 12 (13).

The error monitoring section 414 is for receiving the detection result in the error detecting section 45 stated above with reference with FIG. 2 to monitor an error of the main signal data. On the occurrence of an error, the emphasis control value/attenuation control value developed by the emphasis and attenuation control signal generating section 413 is finely adjusted, with this fine adjustment being repeated until the error disappears ultimately.

The above-mentioned features of the sections 411 to 414 are realizable in a manner that the CPU 41-1 reads out an emphasis and attenuation control program stored in, for example, the memory section 41-2 and operates in accordance with the program read out.

A detailed description will be given hereinbelow of an operation (waveform control at backplane transmission) of the node 1 thus constructed according to this embodiment. In the following description, for convenience only, the foregoing units 11-i, 12 and 13 are not discriminated, but will sometimes be expressed simply as a “main signal unit 11”.

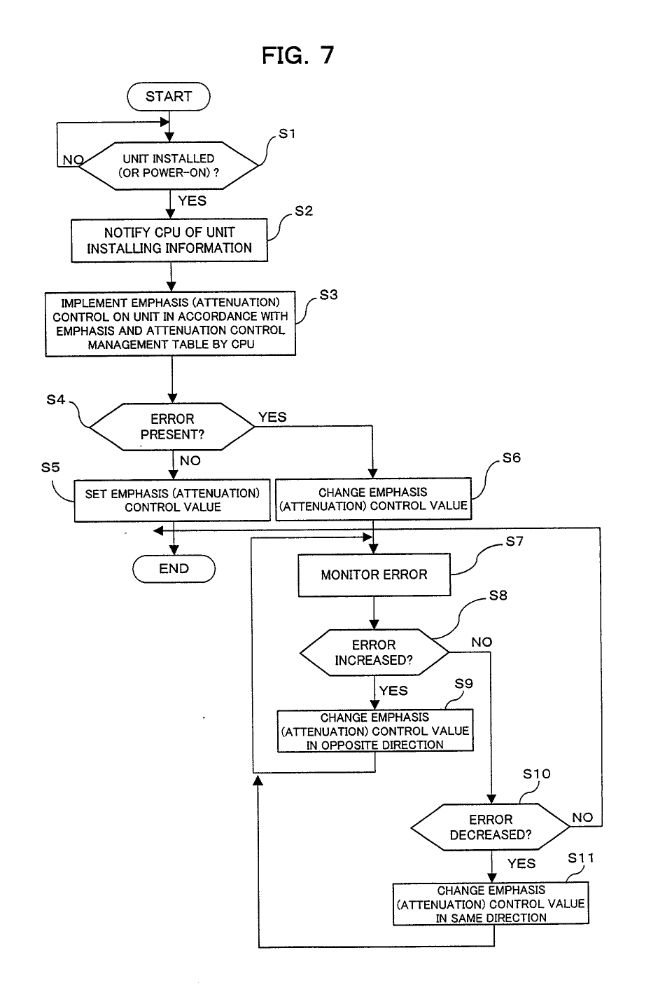

First, as illustratively shown in FIG. 6, when a transmission side main signal unit 11 (main signal unit “1”) is installed (inserted) in a predetermined slot of the shelf 2 (backplane 3) and the connectors 51 and 52 are coupled to each other (if the answer of a step S1 in FIG. 7 shows “YES”), the aforesaid unit installing information detecting section 33 of the main signal unit 11 detects the slot address data corresponding to the hard pin setting, with the slot address data being communicated through the backplane 3, the HUB unit 30 and the optical link 5 to the CPU 41-1 of the control unit 40 (step S2 in FIGS. 6 and 7).

In the CPU 41-1, when the installing slot position information collecting section 411 collects (detects) the aforesaid slot address data (step S2′ in FIG. 6), the management table generating section 412 determines an emphasis quantity (emphasis control value) corresponding to that slot address data, with that information being registered in the management table 61. Therefore, the emphasis and attenuation control signal generating section 413 refers to this management table 61 to generate an emphasis control signal for the installed main signal unit 11, and sends it through the backplane 3 to the emphasis control section 34 of the same main signal unit 11 (step S3 in FIGS. 6 and 7).

The emphasis control section 34 controls (sets) an output buffer of the transmitter 32 in accordance with the received emphasis control signal to perform the “pre-emphasis” control (setting) mentioned above with reference to FIG. 3A. Thus, the main signal unit “1” can forward the main signal data in an optimum amplitude condition according to transmission distance on the backplane 3 [main signal line 31-i (32-i)] with respect to the receive side main signal unit 11 (main signal unit “2”).

In addition, in the receive side main signal unit “2”, the receiver 41 receives the main signal data from the transmitter 32 through the backplane 3 to accomplish the error correction through the use of FEC as stated above with reference to FIG. 2. At this time, if an error exists in the main signal data, the error detecting section 45 detects that error and notifies the CPU 41-1 of it.

In the CPU 41-1, as FIG. 7 shows, the error monitoring section 414 monitors the error notification (step S4), and if the error notification is absent (“NO” decision in step S4), fixes the emphasis control value to the initial value (step S5), while if the error notification is present (“YES” decision in step S4), changes the emphasis control value (sends margin information on the emphasis control value; step S6) and continues the monitoring operation (step S7).

As a result, if the error notification frequency (occurrence frequency) increases as compared with that before the change of the emphasis control value (if the answer of step S8 shows “YES”), the emphasis and attenuation control signal generating section 413 changes the emphasis control value in a direction opposite to the direction of the change immediately before (step S9). On the other hand, if the error occurrence frequency decreases with respect to that before the change of the emphasis control value (if the answer of step S10 shows “YES”), the emphasis and attenuation control signal generating section 413 changes the emphasis control value in a direction identical to the changing direction immediately before (step S11). If, in the step S10, the error occurrence frequency does not indicates a decrease, the operational flow returns to the step S4 and subsequent steps.

In this way, if an error occurs in the main signal data (“YES” decision in step S4), the emphasis and attenuation control signal generating section 413 finely adjusts the emphasis control value until that error disappears (or reduces to a minimum) (until step S4 indicates “NO” decision), and ultimately fixes the emphasis control value to a value at which no error occurs (or error is at a minimum) (step S5).

In consequence, further thanks to the error correction function by the FEC stated above, main signal data (with an error correction code) on the backplane 3 can be normally transmitted with extreme stability irrespective of being very-fast signal data on the order of Gbps (3.375 to 6.75 Gbps).

In this connection, as the operation to be conducted for when a receive side main signal unit 11 is installed, the “attenuation (attenuator)” control for the main signal unit 11 is implemented instead of the “emphasis” control, as written in the parentheses in the flow chart of FIG. 7. In addition, at the start-up (power-on) of the apparatus, the similar operations are respectively conducted with respect to the transmission side/receive side main signal units 11 already installed, thus adjusting and setting the emphasis (attenuation) control value to an optimum value.

Moreover, also in the receive block 20, the emphasis (attenuation) control is implemented according to the inter-slot transmission distance as in the case of the transmission block 10, thereby compensating for the waveform deterioration of the main signal data which travels on the backplane 3.

As described above, with the node 1 according to this embodiment, the waveform of the main signal data traveling on the backplane 3 is emphasis- (attenuation-) controlled according to transmission distance on the basis of the waveform correction information (management table 61) corresponding to the transmission distance (positional relationship between slots) of the main signal data on the backplane 3, which is determined on the basis of the slot position (slot address data) on the main signal unit 11 and the (output/input) port position information on the transmission circuit 14-i (16-i)/reception circuit 15-i (17-i) installed in the main signal unit 11, thereby accomplishing the automatic optimum adjustment (compensation). With this, even if the basic bit rate of the main signal data on the backplane 3 is set at a very-high bit rate on the order of Gbps such as 2.5 to 5.0 Gbps, it is possible to reform (compensate for) the waveform deterioration of the main signal data which occurs noticeably at the very-fast transmission.

In addition, in this embodiment, since the error correction function (circuit) depending on the FEC is installed in the transmission circuit 14-i (16-i) and the reception circuit 15-i (17-i), certain error correction is feasible even at very-fast transmission on the order of Gbps where an error occurs stemming from even slight variation in apparatus environment (temperature or power-supply voltage), disturbance, or the like.

That is, the automatic optimum adjustment of the backplane interface 3 is made according to the difference in installing slot position of the main signal unit 11.

Accordingly, it is possible to stably and normally achieve the very-fast backplane transmission at all times while maintaining the signal quality needed for the main signal data transmission between the main signal units 11, which realizes a very-fast large-capacity node 1 capable of dealing with a bit rate (capacity) of 40 to 80 Gbps without increasing the degree of parallelism (number of signal lines) of the main signal data to be transmitted on the backplane 3.

However, the error correction function based on the FEC is not always required provided that a bit rate, which allows the backplane transmission to be sufficiently stably achievable with only the waveform control by the aforesaid emphasis (attenuation) control, is chosen as the basic bit rate of the main signal data on the backplane 3.

In addition, in the above-described embodiment, at the installing of the main signal unit 11, the start-up of the apparatus or the like, the control unit 40 (CPU 41-1) automatically collects slot address data to generate waveform correction information (management table 61) according to transmission distance between the slots for implementing the aforesaid emphasis (attenuation) control on the basis of the generated waveform correction information. Therefore, there is no need to manually set the waveform correction information for the emphasis (attenuation) control, which considerably simplifies the setting work for the waveform correction information for the emphasis (attenuation) control and prevents the man-made setting mistake or the like.

Although the above-described example can deal with both the emphasis control for the transmission side main signal unit 11 [transmission circuit 14-i (16-i)] and the attenuation control for the receive side main signal unit 11 [reception circuit 15-i (17-i)], the implementation of any one of them is also acceptable.

That is, it is also appropriate that the output waveform of the main signal data of the transmission circuit 14-i (16-i) is fixed in a state where the emphasis control is executed to the slot separation corresponding to the longest transmission distance and, in the reception circuit 15-i (17-i), the amplitude of the main signal data is controlled to attenuate as its transmission distance becomes shorter, or that, in contrast, in the transmission circuit 14-i (16-i), the emphasis quantity is controlled to increase as the main signal data travels a longer transmission distance.

This requires only the emphasis control or attenuation control for any one of the transmission side and the receive side.

In addition, in the above-described example, although the CPU 41-1 of the control unit 40 placed independently of the main signal unit 11 is in charge of the automatic setting of the optimum emphasis control value for the transmission circuit 14-i (16-i) and the automatic setting of the optimum attenuation control value for the reception circuit 15-i (17-i), it is also appropriate that the same setting are automatically made through the communications between the transmission circuit 14-i (16-i) and the reception circuit 15-i (17-i).

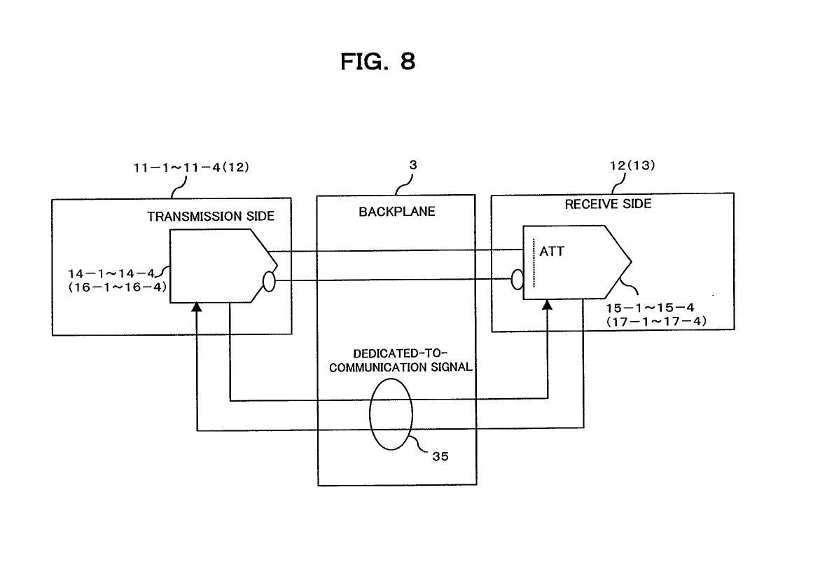

That is, for example as shown illustratively in FIG. 8, separately from the main signal line 31-i (32-i), a communication line(s) 35 for interchange of information [slot address data, emphasis (attenuation) control value, margin information, or the like] needed for the aforesaid emphasis and attenuation control is installed between the transmission circuit 14-i (16-i) and the reception circuit 15-i (17-i) so that the transmission circuit 14-i (16-i) and the reception circuit 15-i (17-i) mutually make communications for the optimum emphasis (attenuation) control value to the main signal data through the communication line 35, thus determining the optimum emphasis (attenuation) control values independently.

In other words, this approach is that the aforesaid CPU 41-1 is installed in both the transmission circuit 14-i (16-i) and reception circuit 15-i (17-i) to make the communication therebetween through the communication line 35, thus determining the optimum emphasis (attenuation) control values for both.

This can realize emphasis and attenuation control similar to that stated above without placing the CPU 41-1 (control unit 40) independently of the main signal unit 11, which permits further size reduction of this node 1. Description of Extensibility of Node 1 Secondly, a description will be given hereinbelow of the extensibility of the node 1.

As described above, this node 1 can deal with a signal capacity of 40 to 80 Gbps with the same or smaller size as compared with the conventional 10 G node 100. Accordingly, if one more system of main signal lines (which sometimes be referred to hereinafter as “fast signal transmission lines”) 31-i and 32-i [2.5 (to 5.0) Gbps×16 parallel] is placed on the backplane 3 (that is, the main signal line 31-i, 32-i is doubled), it is possible to provide a node 1 capable of dealing with a signal capacity up to 160 Gbps.

In this case, a problem is whether or not the needed free space exists on the backplane 3. However, compared with a case in which parallel signal wiring as extremely large as 311 Mbps×128 parallel or 622 Mbps×64 parallel is provided on a backplane interface in order to realize a node capable of dealing with 40 Gbps through the use of a backplane interface for 10 Gbps, sufficient free space may be securable.

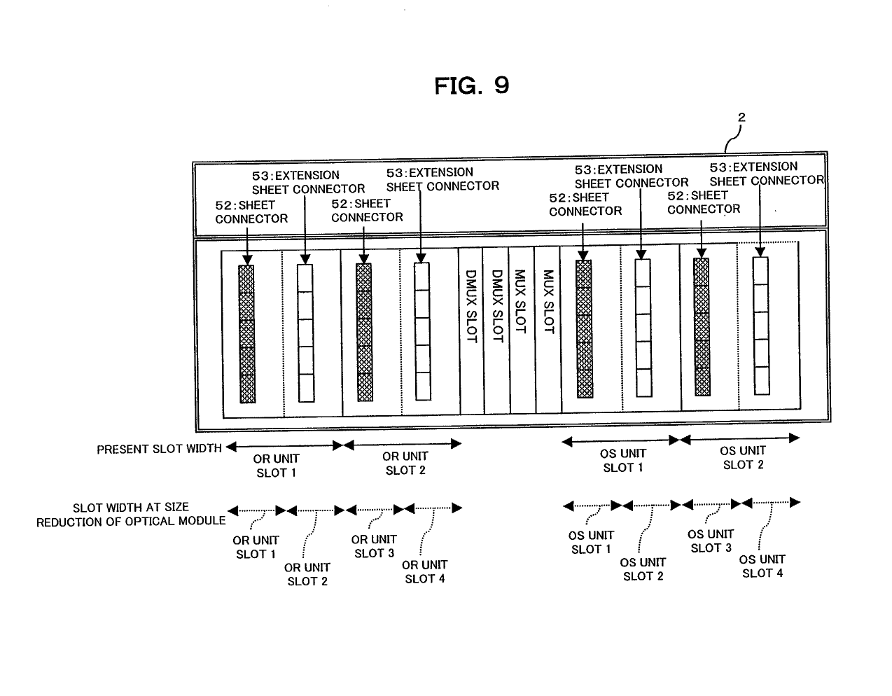

In addition, for example, as shown in FIG. 9, it is considered that, owing to high-density integration in the future, the main signal unit 11 itself can be size-reduced to the extent that permit units corresponding to two slots to be installed in one slot of the existing shelf 2. Incidentally, the present slot width is approximately 70 mm (millimeter) for the optical sending unit (OS) 13 and the optical receiving unit (OR) 21, and is approximately 40 mm for the IFS 11-i and 23-i.

That is, if the size (slot width) of these main signal units 11 can be reduced to half the present dimension or a smaller dimension in the future, the main signal units corresponding to a plurality of slots can be installed in one slot of the existing shelf 2.

Accordingly, for example, assuming that the size reduction of the optical sending unit 13 and the optical receiving unit 21 will become achievable in the future, as shown in FIG. 9, in addition to the existing sheet connector 52, in preparation for future extension, a sheet connector (extension connecting section) 53 is installed in each of the existing slots (OS slots, OR slots) for the optical sending unit 13 and the optical receiving unit 21 in the shelf 2 (backplane 3).

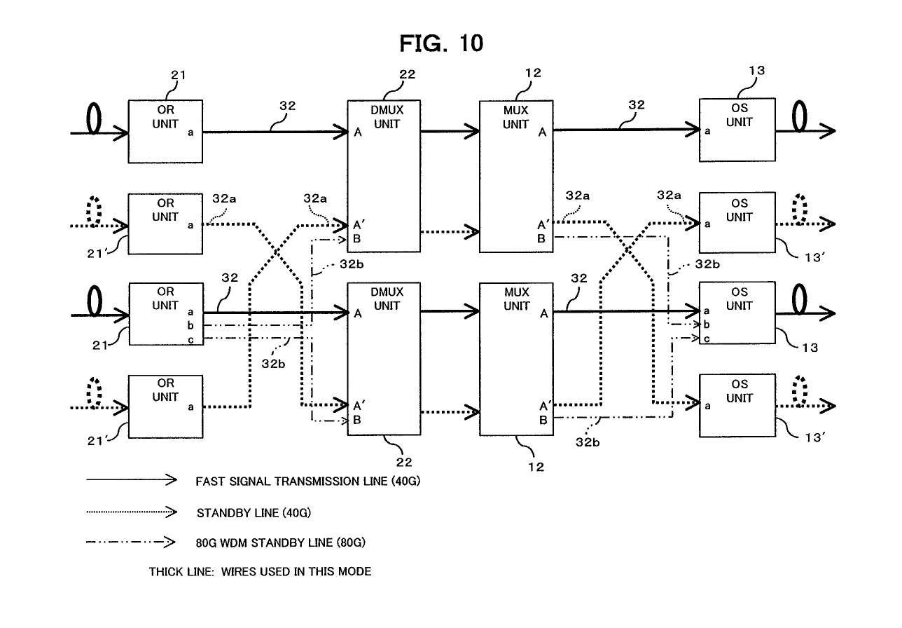

For example, as shown in FIG. 10, on the backplane 3, there are further installed extension (enlargement) signal lines (fast signal transmission lines) 32a (indicated by thick broken line arrows) which permit communications between a optical sending unit 13′, a optical receiving unit 21′, additionally set and connected to the extension sheet connector 53, and the existing multiplexing unit 12 or demultiplexing unit 22.

However, in this case, with respect to the multiplexing unit 12 and the demultiplexing unit 22, through high-density integration of processing circuits, their capacities are enlarged so that the existing slots can cope with the extensions of the optical sending unit 13 and the optical receiving unit 21. In addition, in FIG. 10, reference numeral 32 (thick solid line arrows) represents wiring corresponding to the existing fast signal transmission line 32-i, and numeral 32b (two-dot chain lines) designates a fast signal transmission line (for 80 Gbps; basic bit rate=5.0 Gbps) to be used for when a unit with a two-wavelength multiplexing function is installed as the optical sending unit 13 and the optical receiving unit 21 as will be mentioned later.

With this arrangement, when the optical sending unit 13′ and the optical receiving unit 21′ are respectively installed through the extension sheet connectors 53 in the slots of the existing two-pairs of optical sending units 13 and optical receiving units 21 as shown in FIG. 10, it becomes possible to install a total of four pairs (two pairs before the extension) of 40-Gbps handling optical sending units 13, 13′ and optical receiving units 21, 21′.

Accordingly, for example, when the basic bit rate of each of the existing fast signal transmission line 32 and the extension fast signal transmission line 32a on the backplane 3 is taken as 2.5 Gbps, a node 1 with a capacity of 80 Gbps is realizable, while if doubled to be 5.0 Gbps, a node 1 with a capacity of 160 Gbps is attainable. In the system menu (network application), one node 1 realizes two systems in the case of 2F-BLSR (2-Fiber-Bidirectional Line Switched Ring), and realizes one system for 4F-BLSR.

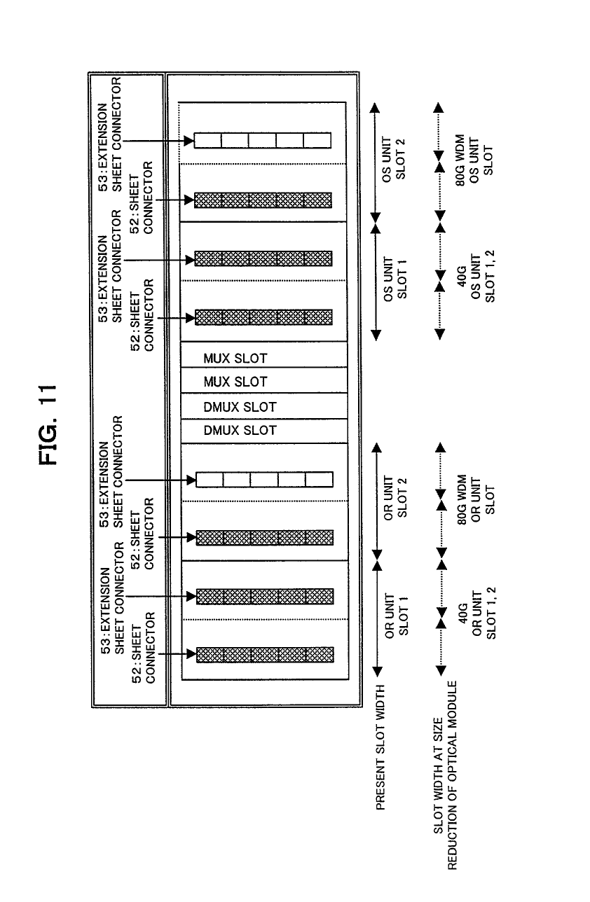

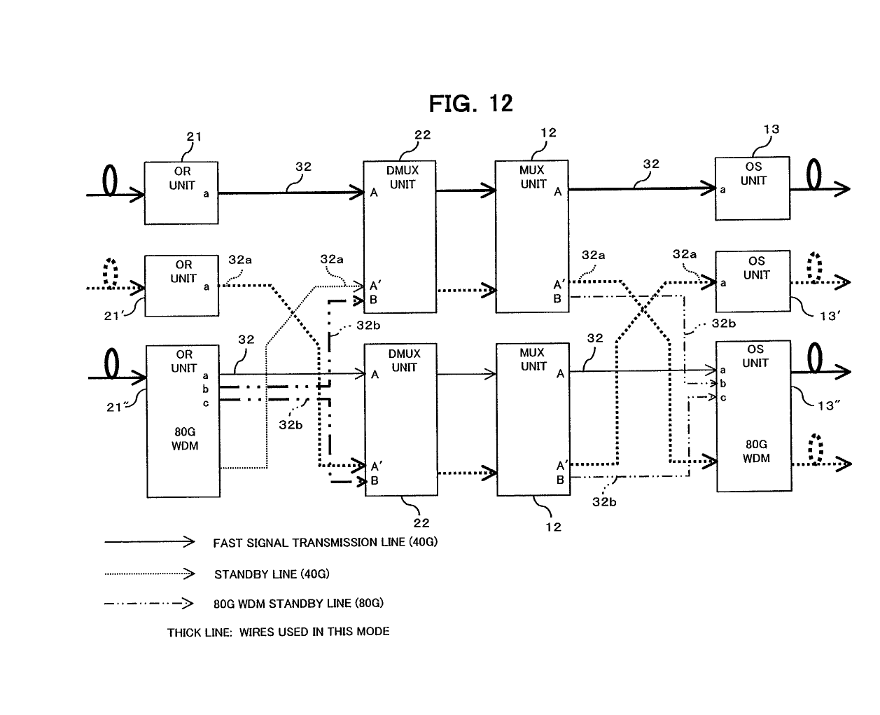

Moreover, when fast signal transmission lines 32b are provided as extension signal wiring as shown in FIG. 10, two pairs of 40-Gbps handling optical sending units 13 and optical receiving units 21 and one pair of 80-Gbps (two-wavelength multiplexing of 40 Gbps) handling (WDM type) optical sending unit 13′ and optical receiving unit 21′ can be installed, for example, as shown in FIGS. 11 and 12.

In this case, in the concrete installing positions, as shown in FIG. 11, the two optical sending units 13 and 13′ are installed in the existing OS slot “1”, and the two optical receiving units 21 and 21′ are installed in the existing OR slot “1”, and further, the 80-Gbps handling WDM type optical sending unit 13″/optical receiving unit 21″with a two-wavelength multiplexing function are installed in the existing OS/OR slot “2”. In addition, in this case, the wiring used on the backplane 3 becomes as shown in FIG. 12 (see thick solid line arrows, thick broken line arrows and thick two-dot chain line arrows).

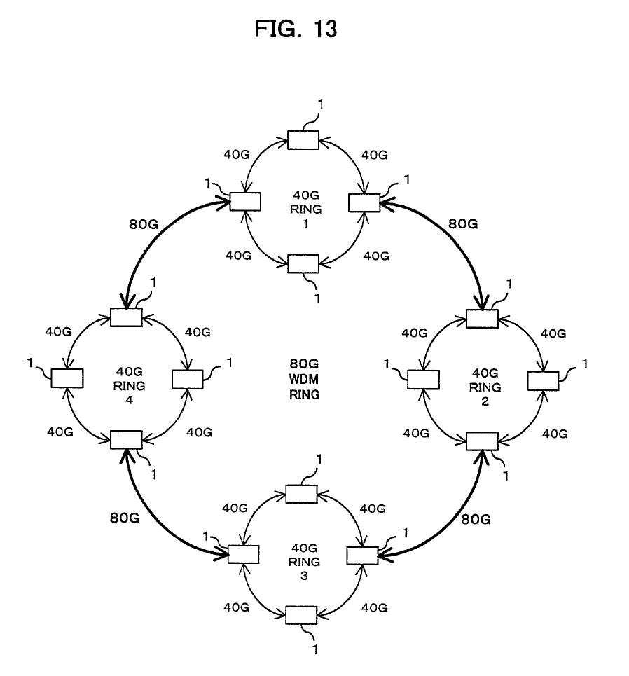

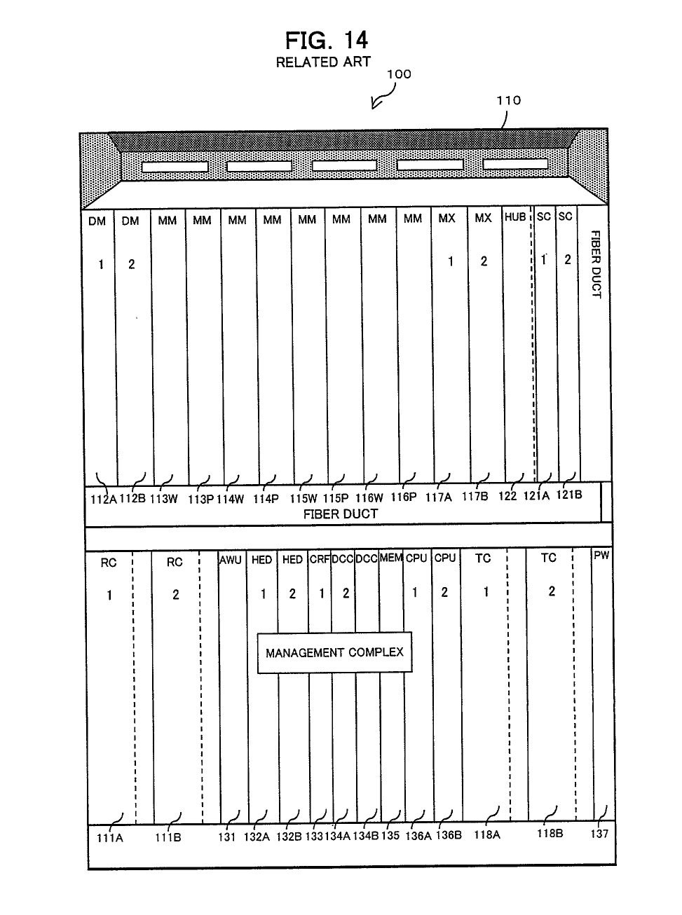

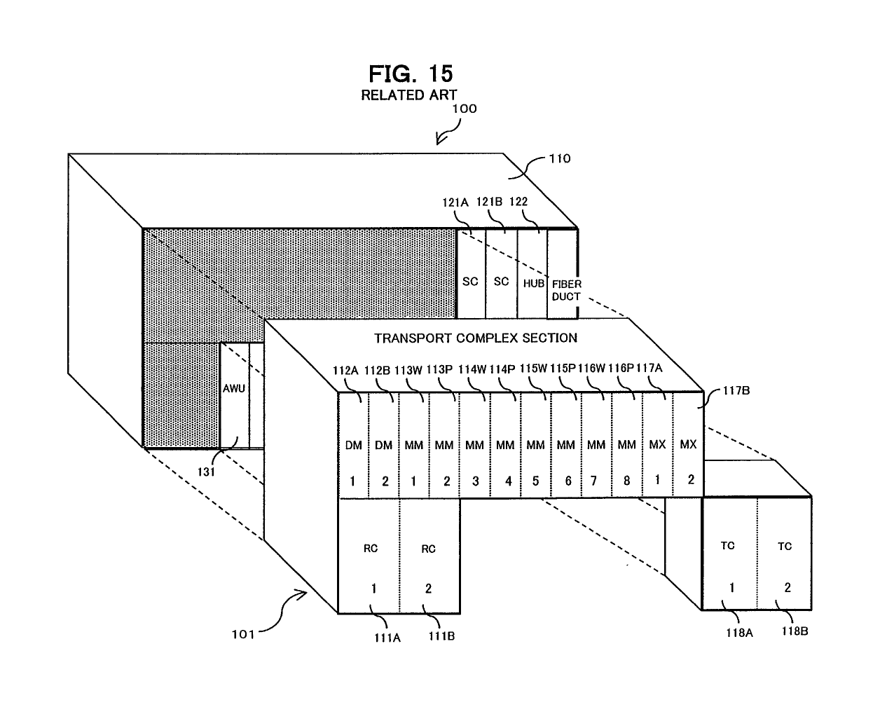

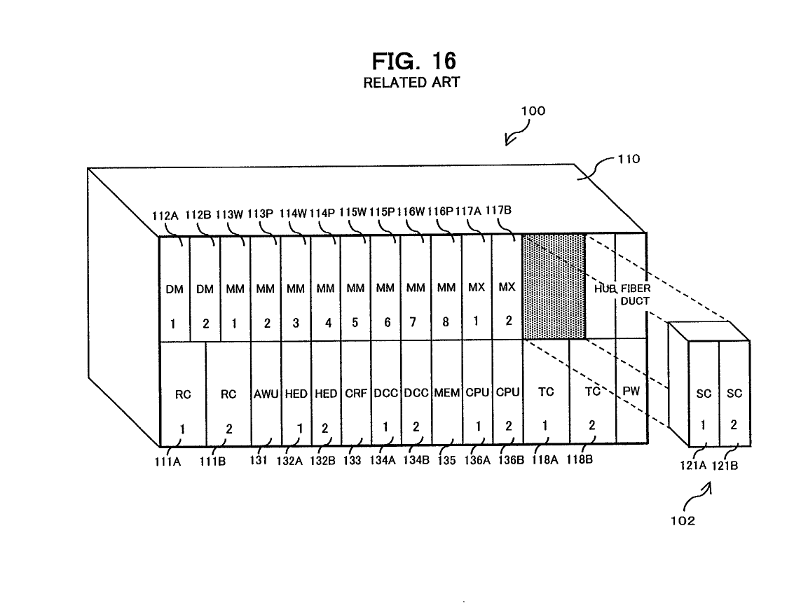

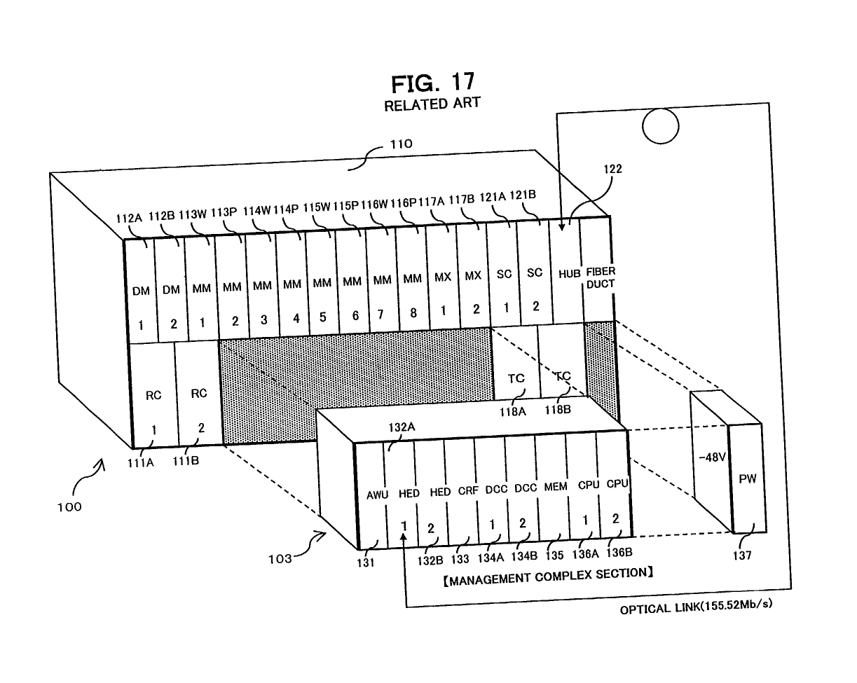

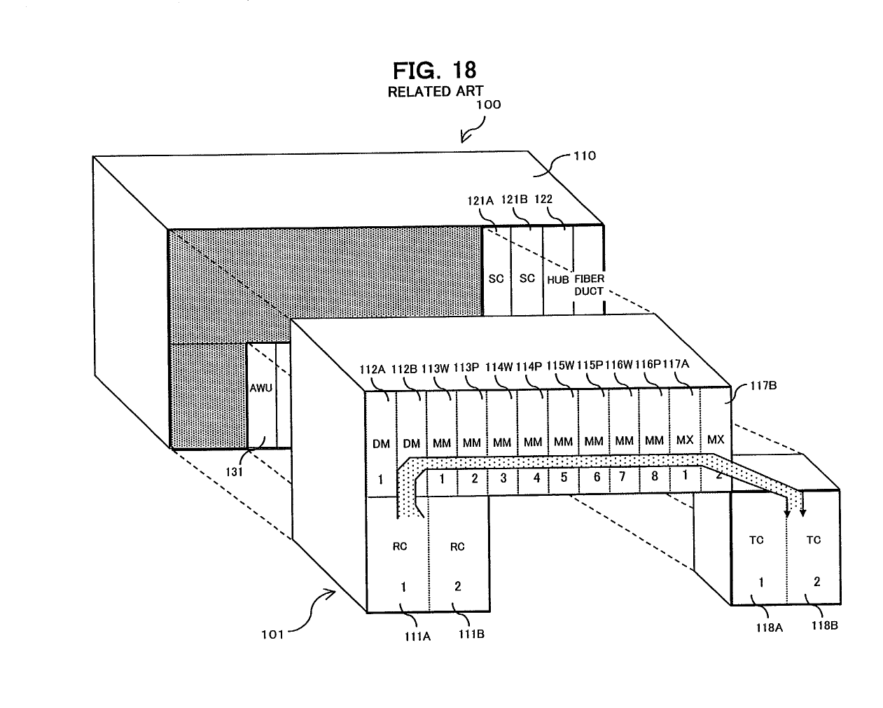

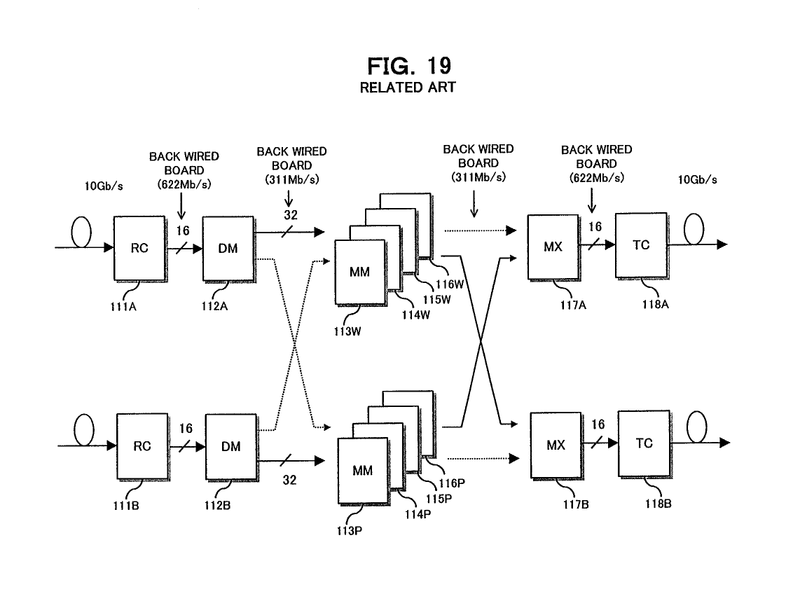

Therefore, for example, as shown in FIG. 13, a plurality of 40-Gbps 2F-BLSRs can be connected with a 80-Gbps WDM signal in a ring-like form to construct a 80-Gbps ring network.

As described above, according to this node 1, since a signal transmission capacity of the backplane 3, which enables stable fast signal transmission, can be increased as needed without increasing the apparatus scale, it is possible to flexibly cope with higher rate and larger capacity of the transmission system in the future, and further to considerably reduce the development cost of new apparatus. Moreover, one node 1 can flexibly cope with various system menus.

Others

In the above-described embodiment, although the upper limit of the basic bit rate of the main signal data on the backplane 3 is set at 5.0 Gbps, the present invention is not limited to this, but a bit rate above 5.0 Gbps is employable as long as the normal backplane transmission is stably accomplished with the waveform control of the main signal data, and in this case, a node 1 with a higher rate and a larger capacity is realizable.

In addition, it is possible that the aforesaid extension sheet connector 53 and signal wiring are provided not only for all the slots of the shelf 2 but also for only a portion thereof as stated above.

It should be understood that the present invention is not limited to the above-described embodiment, and that it is intended to cover all changes and modifications of the embodiments of the invention herein which do not constitute departures from the spirit and scope of the invention.

What is claimed is:

1. A communication node comprising:
a backplane transmission circuit for accomplishing transmission of a signal between communication units installed in a plurality of slots; and
a signal waveform control unit for controlling a waveform of said signal on the basis of position information on said communication unit installing slots in said backplane transmission circuit.

2. A communication node according to claim 1, wherein said signal waveform control unit includes:
an installing slot position information collecting section for collecting said communication unit installing slot position information; and
a waveform correction information generating section for generating waveform correction information corresponding to a transmission distance of said signal on the basis of said installing slot position information collected in said installing slot position information collecting section so that the waveform control is implemented on the basis of the waveform correction information generated in said waveform correction information generating section.

3. A communication node according to claim 1, wherein a transmission circuit with a transmission signal amplitude control function is provided in said communication unit on a signal transmission side so that said signal waveform control unit implements the waveform control by controlling an amplitude control value in said transmission circuit.

4. A communication node according to claim 2, wherein a transmission circuit with a transmission signal amplitude control function is provided in said communication unit on a signal transmission side so that said signal waveform control unit implements the waveform control by controlling an amplitude control value in said transmission circuit.

5. A communication node according to claim 1, wherein a reception circuit with a receive signal amplitude control function is provided in said communication unit on a signal receive side so that said signal waveform control unit is implements the waveform control by controlling an amplitude control value in said reception circuit.

6. A communication node according to claim 2, wherein a reception circuit with a receive signal amplitude control function is provided in said communication unit on a signal receive side so that said signal waveform control unit is implements the waveform control by controlling an amplitude control value in said reception circuit.

7. A communication node according to claim 3, wherein a reception circuit with a receive signal amplitude control function is provided in said communication unit on a signal receive side so that said signal waveform control unit is implements the waveform control by controlling an amplitude control value in said reception circuit.

8. A communication node according to claim 4, wherein a reception circuit with a receive signal amplitude control function is provided in said communication unit on a signal receive side so that said signal waveform control unit is implements the waveform control by controlling an amplitude control value in said reception circuit.

9. A communication node according to claim 1, wherein said signal waveform control unit is provided in each of said signal transmission side communication unit and said signal receive side communication unit so that said signal waveform control units make communication with each other to determine an amplitude control value of said signal for accomplishing the waveform control.

10. A communication node according to claim 1, wherein each of said communication units is equipped with an error correcting circuit for correcting an error of said signal.

11. A communication node according to claim 10, wherein said error correcting circuit in said communication unit on a signal transmission side is made to add error correction information for error correction to said signal and said error correcting circuit in said communication unit on a signal receive side is made to perform the error correction on the basis of said error correction information added to said signal.

12. A communication node according to claim 1, wherein said backplane transmission circuit includes:
an extension connection section used for additionally installing a communication unit for said slot; and
an extension signal wiring section for establishing communication between the communication unit additionally installed and connected to said extension connection section and the other existing communication unit.

13. A communication unit installed in each of a plurality of slots of a communication node which includes a backplane transmission circuit for accomplishing transmission of a signal between the communication units installed in said plurality of slots, said unit comprising:
a transmission circuit for transmitting a signal to the communication unit installed in another slot of said backplane transmission circuit; and
a transmission side waveform control circuit for controlling a waveform of said signal transmitted from said transmission circuit on the basis of installing slot position information on the communication unit installed in said another slot.

14. A communication unit installed in each of a plurality of slots of a communication node which includes a backplane transmission circuit for accomplishing transmission of a signal between the communication units installed in said plurality of slots, said unit comprising:
a reception circuit for receiving a signal from the communication unit installed in another slot of said backplane transmission circuit; and
a receive side waveform control circuit for controlling a waveform of said signal received in said reception circuit on the basis of installing slot position information on the communication unit installed in said another slot.

15. A communication unit installed in each of a plurality of slots of a communication node which includes a backplane transmission circuit for accomplishing transmission of a signal between the communication units installed in said plurality of slots, said unit comprising:
a transmission circuit for transmitting a signal to the communication unit installed in another slot of said backplane transmission circuit;
a reception circuit for receiving another signal from the communication unit installed in said another slot of said backplane transmission circuit; and
a waveform control circuit for controlling at least one of waveform of said signals based on the communication unit installing position information on the communication unit installed in said another slot.
